(19) United States
(12) Patent Application Publication
(10) Pub. No.: US 2004/0195187 A1
(43) Pub. Date: Oct. 7, 2004

(54) Inhibiting scale deposition in oilfield tubulars

(76) Inventors: Jeroen Groenenboom, Rijswijk (NL); Sau-Wai Wong, Rijswijk (NL); Gerrit Nitters, Houston, TX (US)

Correspondence Address: Del S Christensen, Shell Oil Company, Intellectual Property, PO Box 2463, Houston, TX, 77252-2463, US

(21) Appl. No.: 10/483,236

(22) PCT Filed: Jul. 9, 2002
(86) PCT No.: PCT/EP02/07638

(30) Foreign Application Priority Data
Jul. 9, 2001 (EP) 013058888

(51) Int. Cl. E21B 43/00; C02F 1/48

(52) U.S. Cl. 210/748; 166/249

(57) ABSTRACT

A method for preventing scale deposition in a fluid that includes water and ions that can produce scale precipitation and deposition flowing through a well and/or other oilfield tubular comprising arranging a liquid whistle for producing acoustic waves in the fluid in the tubular, and allowing at least part of the fluid that flows through the tubular to pass through the liquid whistle to generate acoustic waves.

The present invention relates to inhibiting the deposition of scale in a fluid that includes water and ions that can precipitate as scale and subsequently be deposited in a conduit, or to removing a scale layer that is formed in the conduit. In the specification and in the claims, ‘inhibiting the deposition of scale’ will be used to refer to both preventing the deposition of scale and to removing a scale layer. The fluid can further include oil and gas.

Common scales that are encountered are BaSO₄, CaSO₄, CaSO₄.2H₂O, SrSO₄ and CaCO₃.

The conduit through which the fluid flows can be a well tubular through which well fluids are passed to surface, or a pipeline.

The present invention particularly relates to preventing scale deposition by applying acoustic energy in the form of acoustic waves in the fluid.

The cleaning action of acoustic waves is well known, see for example U.S. Pat. No. 3,648,769. It is further known to remove sulphate scale by applying low-frequency acoustic energy, see International patent application publication No. 96/07 763.

The known methods require that external energy is supplied to the device that generates the acoustic waves.

German patent publication DE 2927671 discloses a method for preventing scale deposition in a heat exchanger at the earth surface. The known device units acoustic waves in a compact heat exchanger chamber to inhibit scale deposition primarily on the outer well of a coiled heating tube inside the chamber.

It is an object of the present invention to provide a method for inhibiting scale deposition in an elongate well or other oilfield tubular by applying acoustic waves without supplying external energy to the device that generates the acoustic waves.

Accordingly the method according to the present invention for preventing scale deposition in a fluid that includes water and ions that can produce scale precipitation and deposition, which fluid flows through a well and/or other oilfield tubular, comprises the steps of arranging a liquid whistle for producing acoustic waves in the fluid in the tubular, and allowing at least part of the fluid that flows through the conduit to pass through the liquid whistle to generate acoustic waves.

A whistle is a device for generating acoustic waves in a liquid-containing fluid, which device comprises a nozzle and a blade that is arranged downstream of the nozzle. During normal operation liquid flowing out of the nozzle forms a jet that impinges on the blade and flows over the blade. The jet flow generate's vortices in the fluid perpendicular to the fluid flow, which vortices cause the blade to vibrate and acoustic waves are generated. Examples of liquid whistles are described in U.S. Pat. No. 3,176,964 and U.S. Pat. No. 5,858,107.

An advantage of the present invention is that the fluid flowing through the conduit drives the acoustic whistle. Because the fluid flowing through the conduit drives the acoustic whistle no external power source is needed.

Suitably the acoustic whistle is so designed that at the prevailing flow rates the frequency of the acoustic waves emitted by the whistle is in the range of from 20 Hz to 30 kHz.

Suitably more than one liquid whistle is arranged in the conduit.

1. A method for inhibiting scale deposition in a fluid that includes water and ions that can produce scale precipitation and deposition, which fluid flows through a well and/or other oilfield tubular, which method comprises the steps of arranging a whistle for producing acoustic waves in the fluid in the tubular, and allowing at least part of the fluid that flows through the tubular to pass through the whistle to generate acoustic waves.

2. The method of claim 1, wherein a series of whistles are arranged at selected intervals along at least part of the length of the tubular.

3. The method of claim 2, wherein said intervals are between 1 m and 100 m.

4. The method of claim 1 wherein the tubular is a production tubing in an oil and/or gas production well.

5. The method of claim 1, wherein the whistle exits acoustic waves having a frequency in the range from 20 Hz to 30 kHz.
